(19) United States
(12) Patent Application Publication
(10) Pub. No.: US 2017/0086113 A1
(43) Pub. Date: Mar. 23, 2017

(54) BASE STATION DEVICE

(71) Applicant: FUJITSU LIMITED, Kawasaki-shi (JP)

(72) Inventor: Masaru Kabashima, Kawasaki (JP)

(73) Assignee: FUJITSU LIMITED, Kawasaki-shi (JP)

(21) Appl. No.: 15/231,887

(22) Filed: Aug. 9, 2016

(30) Foreign Application Priority Data
Sep. 17, 2015 (JP) 2015-183847

(51) Int. Cl. H04W 36/08; H04W 28/22; H04L 29/06

(52) U.S. Cl. CPC H04W 36/08; H04L 69/28; H04W 28/22; H04W 88/08

(57) ABSTRACT

A base station device including a communication unit which connects wirelessly to, and communicates with, a terminal device located within a range capable of wireless communication, and a processing unit which carries out a search request process of requesting the terminal device to search for a base station device, to which the terminal device is capable of connecting, and to transmit base station information acquired by the search to the base station device, wherein the processing unit acquires operational information indicating change in an operational state of the terminal device, and carries out the search request process when it is determined based on the acquired operational information that the terminal device is in a first state in which the terminal device is capable of performing the search for a base station device.

### CROSS-REFERENCE TO RELATED APPLICATION

This application is based upon and claims the benefit of priority of the prior Japanese Patent Application No. 2015-183847, filed on Sep. 17, 2015, the entire contents of which are incorporated herein by reference.

### FIELD

The present invention relates to a base station device.

### BACKGROUND

Heterogeneous networks (HeTNeTs) are attracting attention as technology relating to communication systems. A HetNet is a network in which, for example, terminal devices are connected wirelessly and a plurality of base station devices having different communicable ranges (called “service areas” below) are arranged hierarchically.

In a HeTNeT, within the service area of a base station device having a broad service area, there are a plurality of base station devices having a narrow service area. The base station devices having a narrow service area are liable to the effects of surrounding buildings and weather due to the weak radio wave output. Consequently, even in the same location, the radio waves reach or do not reach a terminal device. Furthermore, in order to achieve efficient wireless communication with a small number of base stations, the base station devices with a narrow service area may, for example, be situated in locations having high traffic, such as event centers, stations, or the like. Accordingly, there are cases where base station devices having a narrow service area are installed temporarily or are made to stop functioning, by powering off, in time bands of low traffic.

In this way, in a HetNet, due to the constant change in the base stations devices which are communicable in a given location, it may be difficult to select a base station device to which to transfer a terminal device in a handover operation.

Therefore, in Long Term Evolution (LTE) communication, an automatic neighbor relation (ANR) function has been introduced in order to improve handover in a HetNet. The ANR function is a function for managing other base station devices which are currently neighboring a particular base station device, as neighboring base station information, on the basis of the results of measurement of the surrounding base station devices by a terminal device. Base station devices are able to improve the success rate of handover by selecting the handover destination on the basis of this neighboring base station information.

Technologies relating to the ANR function are disclosed in Japanese National Publication of International Patent Application No. 2002-524921, Japanese Laid-open Patent Publication No. 2010-50969, Japanese National Publication of International Patent Application No. 2012-533939, and Japanese National Publication of International Patent Application No. 2014-522203.

### SUMMARY

However, there are cases where, depending on the state of the terminal device, it is not possible to measure the surrounding base station devices. Furthermore, there are also cases where, depending on the state of the terminal device, it is not possible to receive the request message from the base station device requesting measurement of the surrounding base station devices. In cases such as this, the base station device is not able to acquire the result of measurement of the surrounding base station devices from the terminal device, and is not able to update the neighboring base station information to the most recent state.

Furthermore, if the base station device is not able to acquire the result of measurement of the surrounding base station devices, for example, then the base station device repeatedly transmits the request message until it is able to acquire the result. In this case, wasteful transmission occurs due to the base station device transmitting the request message multiple times until being able to acquire the result of measurement of the surrounding base station devices.

According to an aspect of the embodiments, a base station device includes

a communication unit which connects wirelessly to, and communicates with, a terminal device located within a range capable of wireless communication; and

a processing unit which carries out a search request process of requesting the terminal device to search for a base station device, to which the terminal device is capable of connecting, and to transmit base station information acquired by the search to the base station device, wherein

the processing unit acquires operational information indicating change in an operational state of the terminal device, and carries out the search request process when it is determined based on the acquired operational information that the terminal device is in a first state in which the terminal device is capable of performing the search for a base station device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the configuration of a communication system 10 according to a first embodiment of the present invention.

FIG. 2 is a diagram illustrating an example of a sequence for acquiring base station information by a periodic acquisition method.

FIG. 3 is a diagram illustrating an example of a sequence in which the base station device fails to acquire base station information in the period acquisition method.

FIG. 4 is a diagram illustrating an example of the configuration of the base station device 200.

FIG. 5 is a diagram illustrating an example of a base station information table 231.

FIG. 6 is a diagram illustrating an example of the configuration of the terminal device 100.

FIG. 7 is a diagram depicting an example of the configuration of the base station control device 300.

FIG. 8 is a diagram depicting an example of a sequence of a base station information update process according to the first embodiment.

FIG. 9 is a diagram illustrating an example of change in the communication rate of the terminal device 100 with the passage of time.

FIG. 10 is a flowchart of a process in which the base station device 200 updates the base station information in accordance with the second embodiment.

FIG. 11 is a diagram illustrating an example of a sequence for detecting a communication preparation state by the base station device 200.

FIG. 12 is a diagram illustrating an example of a sequence for detecting a disconnection waiting state performed by the base station device 200.

FIG. 13 is a diagram illustrating an example of change in the communication rate of the terminal device 100 with the passage of time.

FIG. 14 is a diagram illustrating a configuration of a base station device 200 according to the third embodiment.

FIG. 15 is a diagram illustrating an example of a flowchart including a communication rate restriction process performed by the base station device 200.

FIG. 16 is a diagram illustrating an example of a sequence of a communication rate restriction process.

FIG. 17 is a diagram illustrating an example of a flowchart of a base station information acquisition process performed by the base station device 200 according to the fourth embodiment.

FIG. 18 is a diagram illustrating an example of the configuration of a base station device 200 according to the fifth embodiment.

FIG. 19 is a diagram illustrating an example of a flowchart of the base station information acquisition process performed by the base station device 200 according to the fifth embodiment.

### DESCRIPTION OF EMBODIMENTS

Embodiments of the present invention are described below.

<Example of Configuration of Communication System>

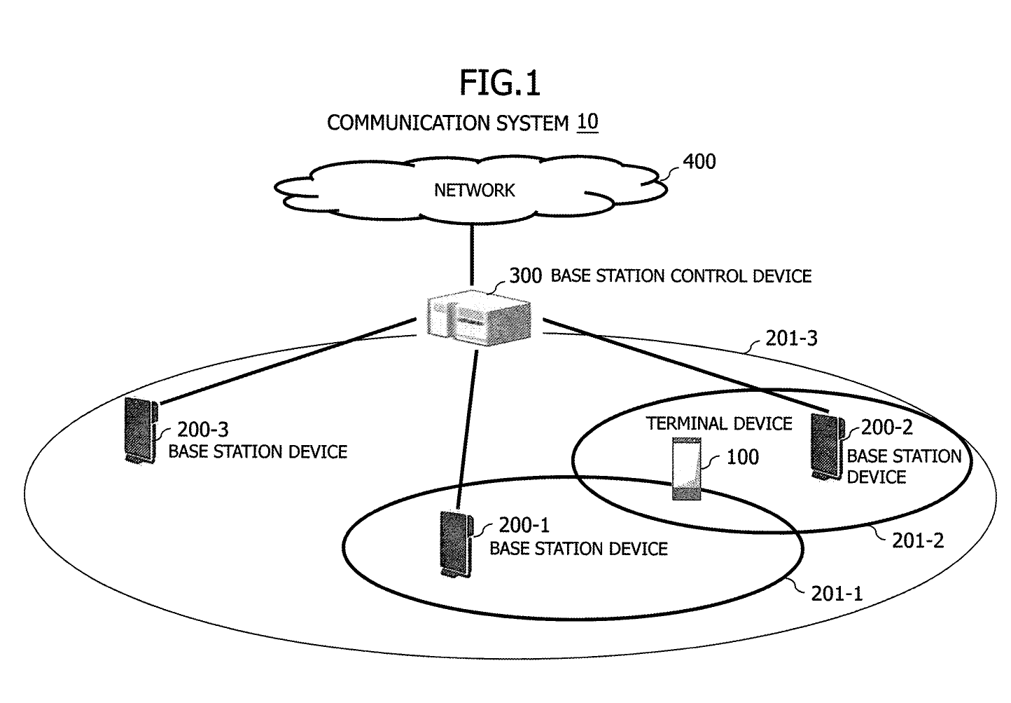

FIG. 1 is a diagram illustrating an example of the configuration of a communication system 10 according to a first embodiment of the present invention. The communication system 10 includes a terminal device 100, base station devices 200-1 to 3, a base station control device 300 and a network 400.

The communication system 10 is a system in which the terminal device 100 communicates with the network 400 and other terminal devices. When the terminal device 100 is communicating with the network 400, the base station devices 200 relay packets which are transmitted and received between network 400 and the terminal device 100. The terminal device 100 performs communication by transmitting and receiving packets to and from the network 400, via the base station device 200 to which it is connected.

Furthermore, the terminal device 100 performs handover for transferring the base station device with which it is communicating, in the event of deterioration of the radio waves due to movement of the terminal device, decline in the communication speed due to increased traffic in the communicating base station device, or the like. In this case, the base station control device 300 determines whether or not to permit transfer of the terminal device 100 by handover, on the basis of information such as the resources of the base station device that is the handover destination. Furthermore, the base station control device 300 carries out authentication of a terminal device which has been transferred by handover from a base station device other than the base station devices 200-1 to 3 under the control of the base station control device 300.

Furthermore, the communication system 10 is a HetNet. The base station devices 200-1 to 3 respectively form service areas 201-1 to 3. The service area is the range in which the terminal device 100 and the base station device 200 are capable of wireless communication. In the example in FIG. 1, the service areas 201-1, 2 are service areas of relatively narrow range compared to the service area 201-3. In the communication system 10 in FIG. 1, the service areas 201-1, 2 of narrow range are contained within the service area 201-3 of broad range, and the base station devices 200-1 to 3 having different service areas are arranged hierarchically.

The base station devices 200 which are installed in the HetNet communication system 10 each have an ANR function. The ANR function is a function which, for example, stores base station information, such as which other base stations are situated surrounding the base station device 200, and selects a handover destination for the terminal device on the basis of the base station information. For instance, the base station device 200-1 in FIG. 1 stores base station information indicating that the base station devices 200-2 and 3 are situated surrounding that the base station device 200-1. The base station devices 200 each receive a search result of base station information from a terminal device 100 served by that base station device, and store the received search result as base station information in an internal memory. By means of the terminal device 100 searching for a base station device, it is possible to acquire information about the base station devices with which the terminal device can actually communicate. The base station devices 200 update the base station information periodically, for instance.

<Periodic Acquisition of Base Station Information>

A method of acquiring base station information is a periodic acquisition method in which base station information is acquired periodically. In a periodic acquisition method, the base station device starts an interval timer, and when the interval timer has expired, transmits a search request to the terminal device.

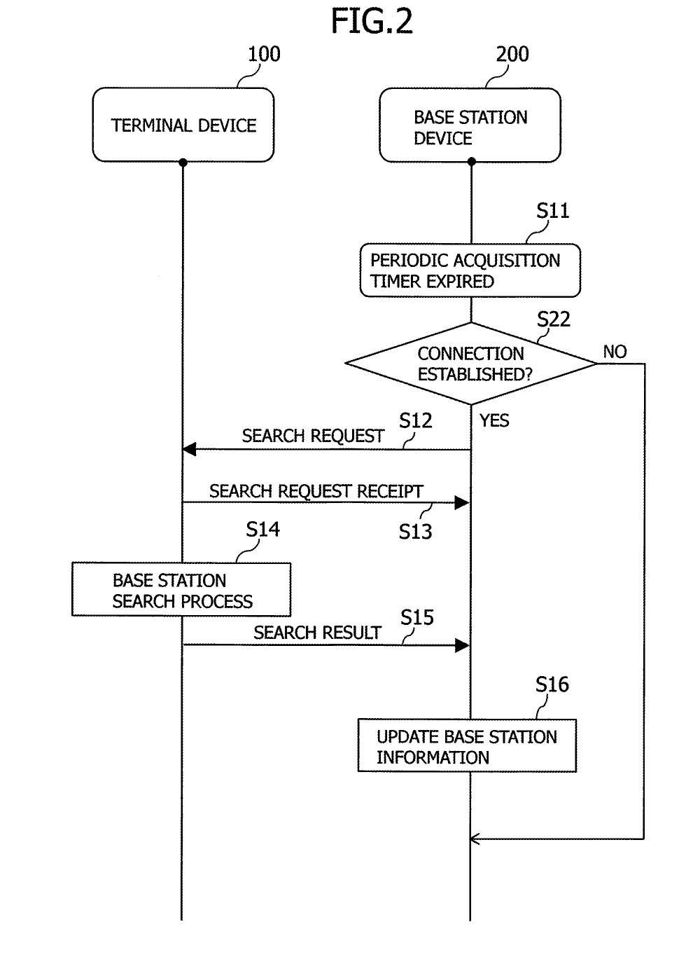

FIG. 2 is a diagram illustrating an example of a sequence for acquiring base station information by a periodic acquisition method. The periodic acquisition method is described below with reference to FIG. 2.

In a connection established state in which a connection between the terminal device 100 and the base station device 200 has been established, the periodic acquisition timer started by the base station device 200 expires (S11). The connection established state is a state in which negotiations for communication between the terminal device 100 and the base station device 200 have been completed and communication can be performed. Furthermore, the periodic acquisition timer is the interval timer described above, and is set to a time of one hour, for example.

When the periodic acquisition timer has expired, the base station device 200 transmits a search request to the terminal device 100 requesting a search for a base station device (S12). When a connection between the terminal device 100 and the base station device 200 has not been established, the base station device is not in a state in which communication with the terminal device 100 is possible, and therefore is not able to transmit the search request. Consequently, the base station device 200 is not able to receive a search result and fails to update the base station information.

Upon receiving the search request, the terminal device 100 transmits a search request receipt to the base station device 200 (S13). The terminal device 100, upon transmitting the search request receipt, searches for base station information (S14). In the search for base station information, the terminal device 100 receives information reported by base station devices at a specific frequency, for instance. The terminal device 100, upon completing the search for a base station device, transmits a search result to the base station device 200 (S15). The base station device 200, upon receiving the search result, updates the base station information stored in the internal memory (S16). In this way, in the periodic acquisition method, the search request is transmitted in accordance with the periodic acquisition timer.

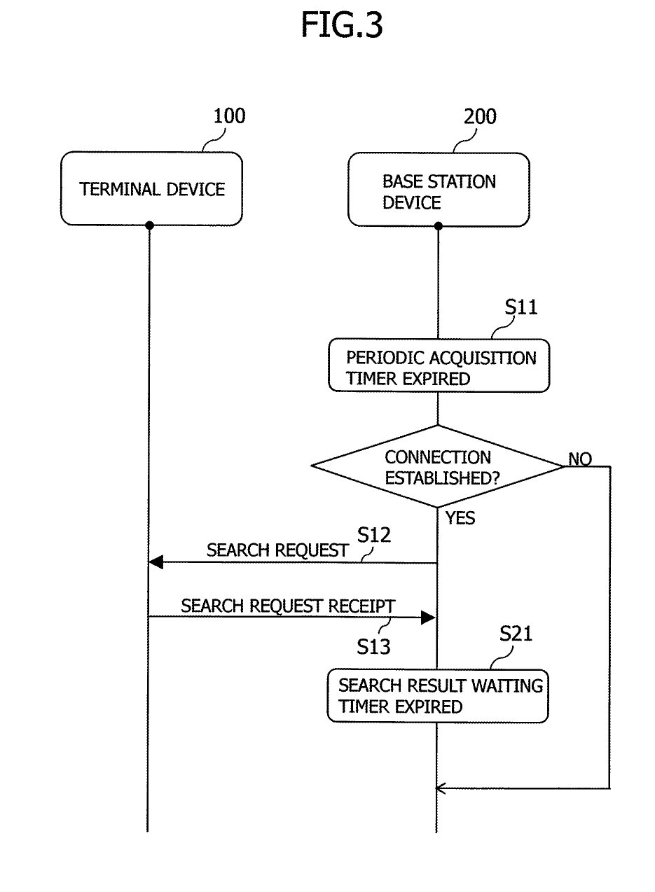

On the other hand, FIG. 3 is a diagram illustrating an example of a sequence in which the base station device fails to acquire base station information in the period acquisition method. A case of failure to acquire base station information in a periodic acquisition method is now described with reference to FIG. 3.

The processing from the expiry of the periodic acquisition timer in the base station device 200 until the transmission of the search result receipt by the terminal device 100 to the base station device 200 (S11 to S13) is the same as FIG. 2. However, in the sequence in FIG. 2, the terminal device 100 is not able to perform a search for a base station device despite having received the search request. The terminal device 100 is not able to search for a base station device in a state where, for example, the terminal device 100 is subjected to such a load that the terminal device 100 is not able to perform a search for a base station device. FIG. 2 is a sequence of a case in which the terminal device 100 is not able to perform a search for base station information, for a reason of some kind, upon receiving a search request. In this case, the terminal device 100 is not able to search for the base station information and therefore is not able to transmit a search result to the base station device 200. Consequently, the base station device 200 ends the process upon expiry of a search result reception timer that is started in order to wait for reception of a search result.

In this way, if the timing at which the periodic acquisition timer in the base station device 200 expires and a search request is transmitted to the terminal device 100 coincides with a state where the terminal device 100 is not able to perform a search for a base station device, then the base station device is not able to receive the search result and fails to update the base station information.

Furthermore, there are cases where the base station device 200 retransmits the search request to the terminal device 100 until a search result is successfully received. However, with this method, the retransmission of the search request is repeated until the terminal device 100 happens to become capable of searching for the base station information, and therefore wasteful transmission occurs.

### First Embodiment

To begin with, a first embodiment will be described.

In the first embodiment, firstly, operational information indicating change in the operational state of the terminal device 100 is acquired, and it is determined from the acquired operational information whether or not the terminal device 100 is in a state capable of performing a search base station information (called “search-capable state” below). If it is determined that the terminal device 100 is capable of performing a search for a base station device, the base station device 200 transmits a search request to the terminal device 100. The hardware configuration of each device in the communication system 10 according to the first embodiment is described below.

<Example of Configuration of Each Device>

Examples of the configuration of each device are described below.

<1. Example of Configuration of Base Station Device>

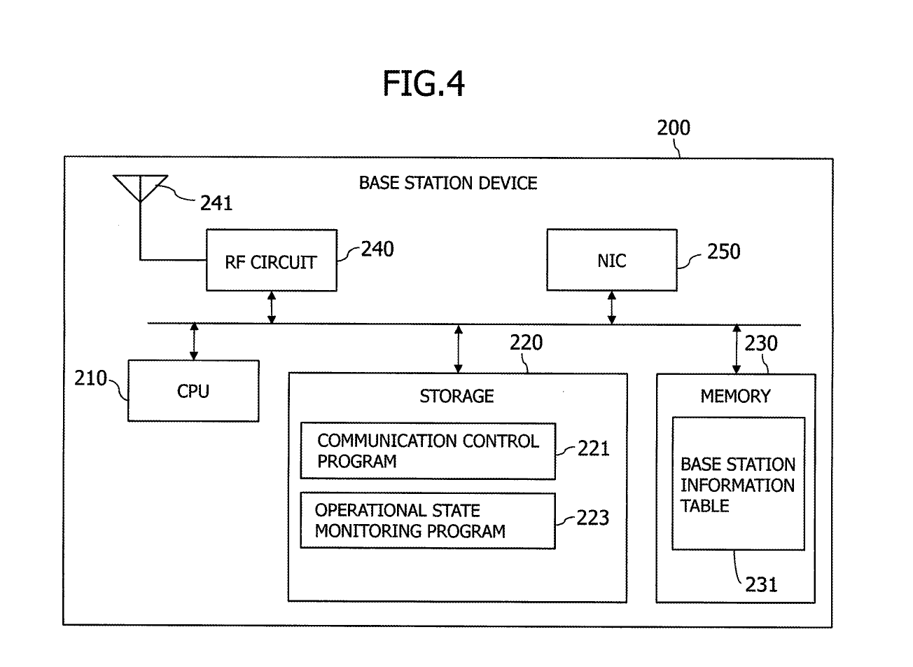

FIG. 4 is a diagram illustrating an example of the configuration of the base station device 200.

The base station device 200 includes a central processing unit (CPU) 210, a storage 220, a memory 230, an RF circuit 240, and a network interface card (NIC) 250. The base station device 200 is, for example, an Evolved Node B (eNB) or Home evolved Node B (HeNB) in LTE communication.

The storage 220 is an auxiliary storage device which stores programs and/or data. The storage 220 stores a communication control program 221 and an operational state monitoring program 223.

The memory 230 is a region to which a program stored in the storage 220 is loaded. Furthermore, the memory 230 is also used as an area where the programs store data, and stores a base station information table 231. The base station information table 231 is a table storing base station information, which is updated when a search result is received from the terminal device 100.

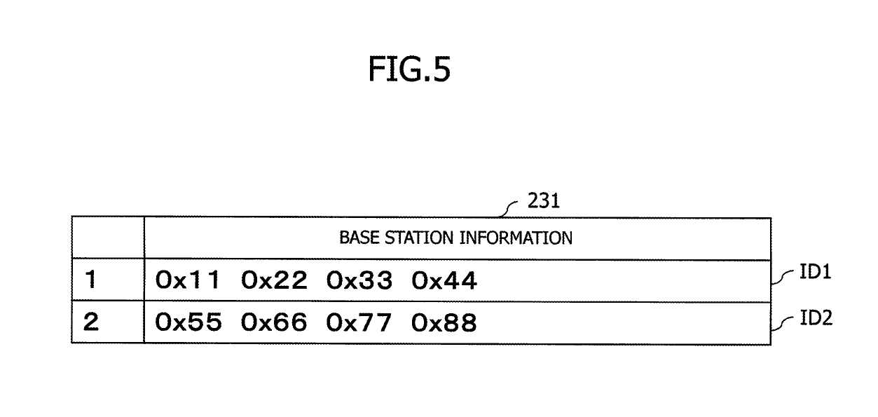

FIG. 5 is a diagram illustrating an example of a base station information table 231. The base station information table 231 stores base station information, and the base station information includes the identifiers of surrounding base station devices. The identifier of a base station device is, for example, Cell-ID, which is represented by a 4-byte value. FIG. 5 is an example of the base station information table 231 of the base station device 200-1. The base station device 200-1 stores, as base station information, an identifier (ID1) of the base station device 200-2, and an identifier (ID2) of the base station device 200-3.

The RF circuit 240 is a circuit which communicates with the terminal device 100 wirelessly. The RF circuit 240 achieves the processing of a transmission unit. The RF circuit 240 has an antenna 241 and transmits and receives wireless signals via the antenna 241.

The NIC 250 is a device which communicates with the base station control device 300. The NIC 250 and the base station control device are connected by, for example, a wired connection via a network cable, or the like.

The CPU 210 is a processor which loads a program stored in the storage 220, to the memory 230, and executes the loaded program to achieve the functions of a processor unit.

The CPU 210 achieves a communication control process by executing the communication control program 221.

The communication control process is a conventional process for controlling wireless communications which is carried out by the terminal device 100. In the communication control process, upon receiving a connection request transmitted from the terminal device 100, the base station device 200 transmits a connection response to the terminal device 100, and carries out a process for connection with the terminal device 100. The connection process is a process for exchanging information, such as the frequency band used for subsequent communication, between the terminal device 100 and the base station device 200. Furthermore, in the communication control process, packets transmitted and received by the terminal device 100 are relayed.

Moreover, the CPU 210 achieves an operational state monitoring process by executing the operational state monitoring program 223. The base station device 200 according to the first embodiment carries out an operational state monitoring process, in addition to conventional processes.

The operational state monitoring process is a process for monitoring the operational state of the terminal device 100, detecting if the terminal device 100 is in a search-capable state, and transmitting a search request. In the operational state monitoring process, the base station device 200 acquires operational information indicating change in the operational state of the terminal device 100, and determines, from the acquired operational information, whether or not the terminal device 100 is in a search-capable state. The base station device 200, upon determining that the terminal device 100 is in a search-capable state, transmits a search request to the terminal device 100. Furthermore, if the base station device 200 determines that the terminal device 100 is not in a search-capable state, then the base station device 200 repeats the acquisition of operational information until determining that the terminal device 100 is in a search-capable state. The operational state of the terminal device 100 is, for example, the communication volume per unit time of the terminal device 100 (called “communication rate” below). For example, if the communication rate of the terminal device 100 is lower than a reference value, then the base station device 200 determines that the terminal device 100 is in a search-capable state. The reference value is, for example, a communication rate at which the load on the CPU 110 is sufficiently low to enable the terminal device 100 to maintain a search-capable state.

In this way, by carrying out an operational state monitoring process, it is possible to transmit a search request when the terminal device 100 is in a search-capable state, and hence the probability of being able to receive a search request, in other words, the probability of being able to update the base station information, is improved.

<Example of Configuration of Terminal Device>

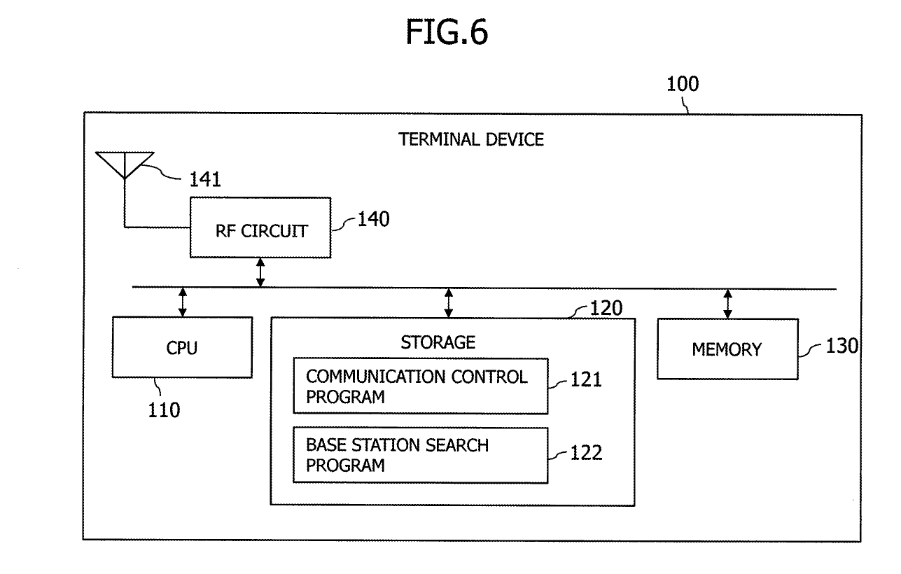

FIG. 6 is a diagram illustrating an example of the configuration of the terminal device 100.

The terminal device 100 includes a CPU 110, a storage 120, a memory 130 and an RF circuit 140. The terminal device 100 is a communication device, such as a smartphone, or tablet, for example.

The storage 120 is an auxiliary storage device which stores programs and/or data. The storage 120 stores the communication control program 121 or the base station search program 122.

The memory 130 is a region to which a program stored in the storage 120 is loaded. Furthermore, the memory 130 is also used as a region for storing data by the program.

The RF circuit 140 is a circuit which communicates wirelessly with the base station device 200. The RF circuit 140 has an antenna 141, and transmits and receives wireless signals via the antenna 141.

The CPU 110 is a processor which loads a program stored in the storage 120, to the memory 130, and executes the loaded program.

The CPU 110 achieves a communication control process by executing the communication control program 121, and achieves a base station search process by executing the base station search program 122.

The communication control process is a conventional process for controlling radio communications which is carried out by the terminal device 100. In the communication control process, the terminal device 100 starts communication due to a request from an application or an operation by a user, for example. Upon starting communication, the terminal device 100 transmits a connection request to a base station device 200 capable of communicating therewith. The terminal device 100 receives a connection response corresponding to the connection request, and when the connection process has been completed, starts the transmission and reception of packets.

The base station search process is a process in which the terminal device 100 performs a search for a base station device and transmits the search result as base station information to the base station device 200. The terminal device 100, upon receiving the search request from the base station device 200, carries out the base station search process if the terminal device 100 is in a search-capable state. The terminal device 100, for example, searches for the base station information by acquiring report information that is reported by the base station devices at a prescribed frequency.

The report information of the base station device includes an identifier of the base station device which uniquely identifies the base station device. Furthermore, the fact that the terminal device 100 can acquire report information for a particular base station device means that the terminal device 100 is located in the service area of the base station device that transmitted the report information. In other words, the base station information retrieved in the search by the terminal device 100 is, for example, information including the identifiers of the base station devices with which the terminal device 100 can connect.

<Example of Configuration of Base Station Control Device>

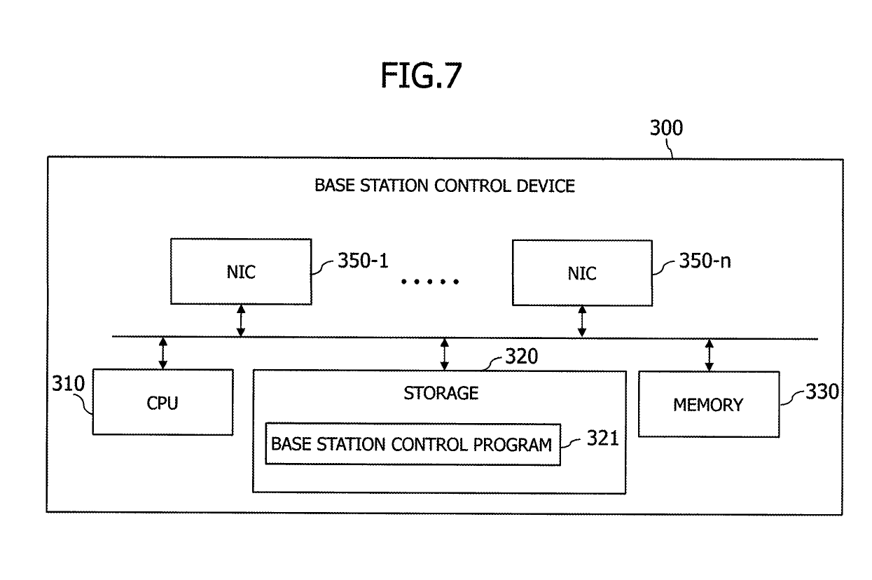

FIG. 7 is a diagram depicting an example of the configuration of the base station control device 300.

The base station control device 300 has a CPU 310, a storage 320, a memory 330 and NICs 350-1 to n. The base station control device 300 is, for example, a mobility management entity (MME).

The storage 320 is an auxiliary storage device which stores programs and/or data. The storage 320 stores a base station control program 321.

The memory 330 is a region to which a program stored in the storage 320 is loaded. Furthermore, the memory 330 is also used as a region where the program stores data.

The NICs 350-1 to n are devices which perform communication between the base station devices 200 and the network 400. The NICs 350 and the base station control device are connected by a wired connection via a network cable, for example.

The CPU 310 is a processor which loads a program stored in the storage 320, to the memory 330, and executes the loaded program.

The CPU 310 achieves a base station control process by executing the base station control program 321.

The base station control process is a process for managing transfer of terminal devices 100 located in the service areas of base station devices 200 which are connected to the base station control device 300, and carrying out authentication of the terminal devices 100. The base station control device 300 receives a handover request transmitted by a terminal device 100 from a base station device 200. The base station control device 300, in response to the handover request transmitted by the terminal device 100, determines whether or not handover is permitted, and transmits a handover permitted or denied indication to the base station device 200. The base station control device 300 determines whether or not to permit handover, for example, on the basis of the state of resources of the base station device that is the transfer destination, or the authentication result for the terminal device 100 based on the handover request.

<Base Station Information Update Process>

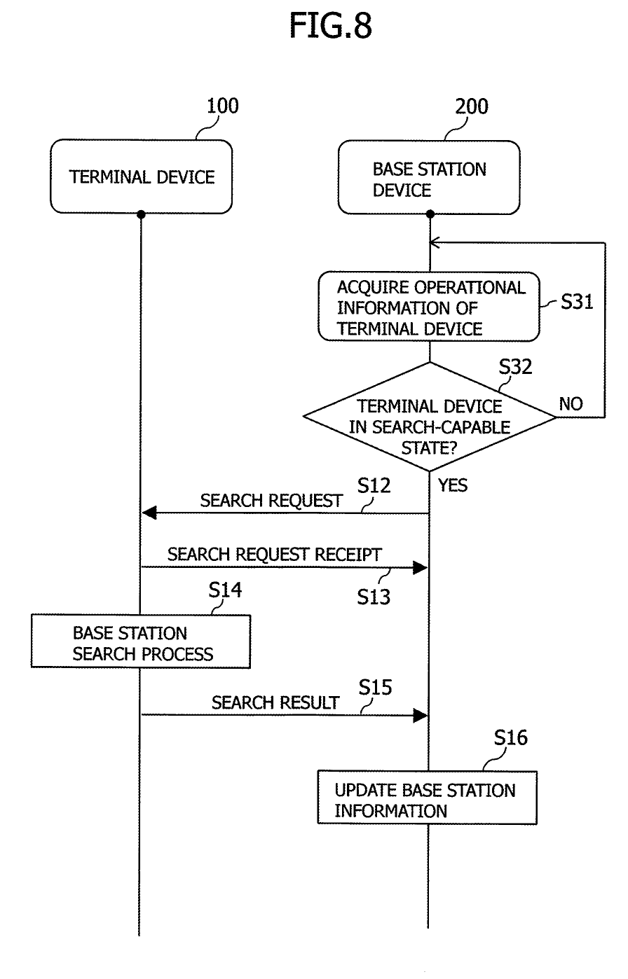

FIG. 8 is a diagram depicting an example of a sequence of a base station information update process according to the first embodiment. The process of updating the base station information is described here with reference to FIG. 8.

The base station device 200 carries out an operational state monitoring process. The base station device 200 acquires the operational information of the terminal device 100, by the operational state monitoring process (S31). The operational information of the terminal device 100 is information indicating change in the operational state of the terminal device, and includes, for example, the communication rate of the terminal device and/or the connection state between the terminal device 100 and the base station device 200, and the like. The base station device 200 determines whether or not the terminal device 100 is in a search-capable state, on the basis of the acquired operational information (S32). If the load on the CPU 110 is high because the communication rate is high, for example, then the terminal device 100 is not able to perform a search in order to acquire base station information. Therefore, the base station device 200 determines that the load on the CPU 110 of the terminal device 100 is low and that the terminal device 100 is in a search-capable state, for example, if the communication rate of the base station device 200 is equal to or lower than a reference value.

The base station device 200, upon determining that the terminal device 100 is not in a search-capable state (No in S32), acquires the operational information of the terminal device again (S31), and determines whether or not the terminal device 100 is in a search-capable state (S32). In this way, the base station device 200 repeats the acquisition of the operational information of the terminal device 100, and the determination of whether or not the terminal device 100 is in a search-capable state, until determining that the terminal device 100 is in a search-capable state.

If it is determined that the terminal device 100 is in a search-capable state (Yes in S32), then the base station device 200 transmits a search request to the terminal device 100 (S33). In an LTE communication system, the search request, for example, involves transmitting a Cell Global ID (CGI) search request using “RRC Connection Reconfiguration”.

Upon receiving the search request, the terminal device 100 carries out a base station search process. In this base station search process, the terminal device 100 transmits a search request receipt to the base station device 200 (S34), and performs a search for base station information (S35). In an LTE communication system, the search request receipt is, for example, “RRC Connection Reconfiguration Complete”.

If the search for base station information is successful, the terminal device 100 transmits a search result containing the base station information to the base station device 200 (S36). In an LTE communication system, the search result is, for example, a Measurement Report containing CGI information. Upon receiving the search result, the base station device 200 updates the base station information in the internal base station information table 231 (S16).

In this way, in the first embodiment, it is determined that the terminal device 100 is in a search-capable state, and a search request is transmitted. Since the base station device 200 transmits a search request after determining that the terminal device 100 is in a search-capable state, then there is a high probability that the terminal device 100 will be in a state capable of searching for the base station information, upon receiving the search request. Therefore, there is a high probability that the base station device 200 will be able to receive a search result from the terminal device 100. In other words, the probability of the base station device 200 updating the base station information is improved, and wasteful communications, such as repeatedly transmitting a search request, can be suppressed.

### Second Embodiment

Next, a second embodiment of the invention will be described.

The second embodiment relates to an example in which it is determined whether or not the terminal device 100 is in a search-capable state, in the operational state monitoring process of the base station device 200.

<State Capable of Searching for Base Station Information>

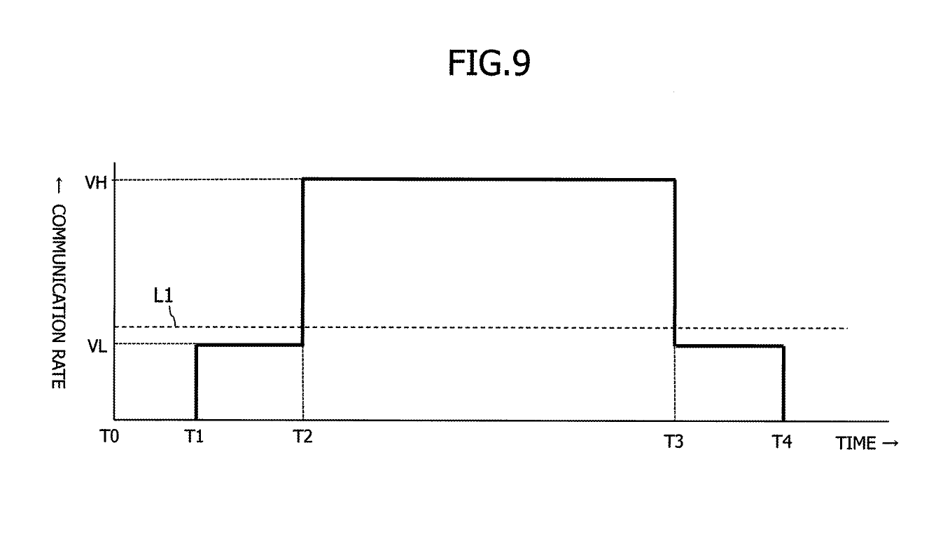

FIG. 9 is a diagram illustrating an example of change in the communication rate of the terminal device 100 with the passage of time. The search-capable state of the terminal device 100 is now described with reference to FIG. 9.

FIG. 9 illustrates a sequence from the establishment of a connection with the base station device 200, when transmission and reception of user data is started due to a user operation or a request from an application, to transmission and reception of the requested user data, until disconnection after completing the transmission and reception of the user data. The description below explains whether or not the base station device 200 determines the terminal device 100 to be in a search-capable state, in each of the time periods in FIG. 9.

In the time period from time T0-T1, the terminal device 100 is in an unconnected state in which no connection has been established with the base station device 200, and no communication is performed. In the unconnected state, the communication rate is 0 bps (bits per second). In this time period, the terminal device 100 and the base station device 200 are not connected and a search request is not able to be transmitted, and therefore, the terminal device 100 is determined not to be in a search-capable state.

The time period from T1 to T2 is a communication preparation period prior to the performance of communication based on the transmission and reception of user data, in which the terminal device 100 establishes a connection with the base station device 200 for the purpose of preparing for the transmission and reception of user data. In the communication preparation period, a connection between the terminal device 100 and the base station device 200 is established, but the communication rate VL is equal to or lower than a reference value L1. The reference value L1 is, for example, a communication rate at which it is surmised that if the communication rate is equal to or lower than the reference value L1, the load on the CPU 110 of the terminal device 100 is small, and the terminal device 100 is probably capable of searching for base station information. In the communication preparation period, a connection with the terminal device 100 is established, and since the communication rate of the terminal device 100 is equal to or lower than the reference value, then the terminal device 100 is determined to be in a search-capable state.

In the time period from T2 to T3, a connection between the terminal device 100 and the base station device 200 is established, and communication is performed by transmission and reception of user data. The communication based on transmission and reception of user data involves a large communication volume, and therefore the communication rate VH of the terminal device 100 in this period is higher than the reference value L1. In this period, the load of the CPU 110 of the terminal device 100 is high, and the terminal device 100 is determined not to be in a search-capable state.

The time period from T3 to T4 is a disconnection wait period of waiting for a disconnection process, after the completion of communication based on the transmission and reception of user data with the terminal device 100. In the disconnection wait period, a connection between the terminal device 100 and the base station device 200 is established, but the communication rate VL is equal to or lower than the reference value L1. In the disconnection wait period, since a connection with the terminal device 100 has been established and the communication rate of the terminal device 100 is equal to or lower than the reference value, then the terminal device 100 is determined to be in a search-capable state.

The time period after T4 is a period after the terminal device 100 has disconnected from the base station device 200. In this period, since the terminal device 100 and the base station device 200 are not connected and a search request is not able to be transmitted, then the terminal device 100 is determined not to be in a search-capable state.

There follows a description of a process in which the base station information is updated by the base station device 200 detecting that the terminal device 100 is in a state indicating a communication preparation period (called “communication preparation state” below) and that the terminal device 100 is in a state indicating a disconnection wait period (called “disconnection preparation state” below).

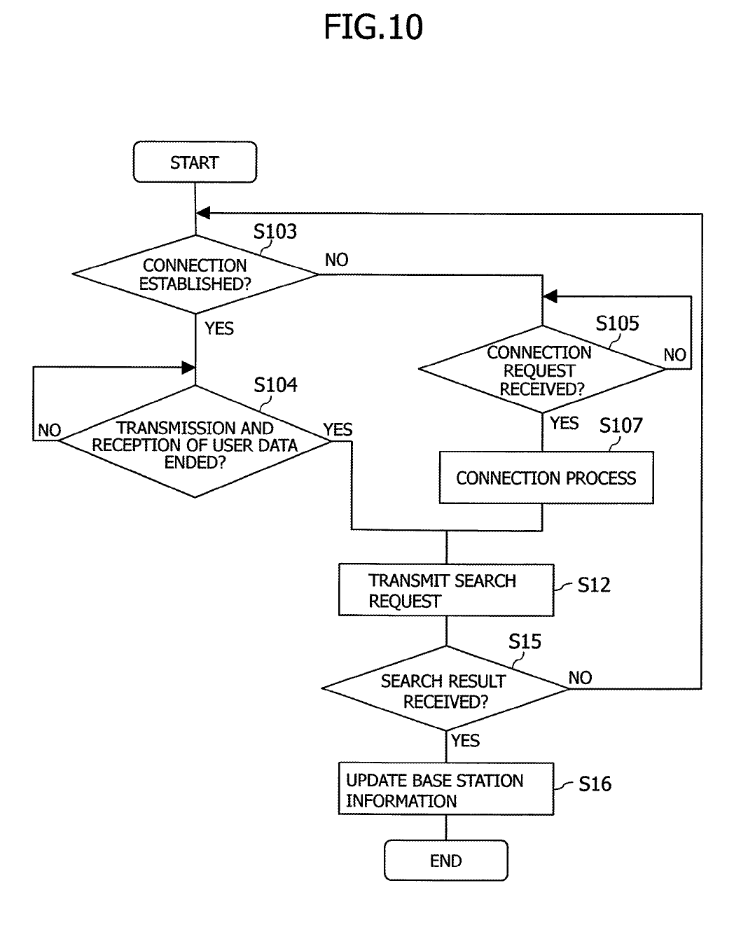

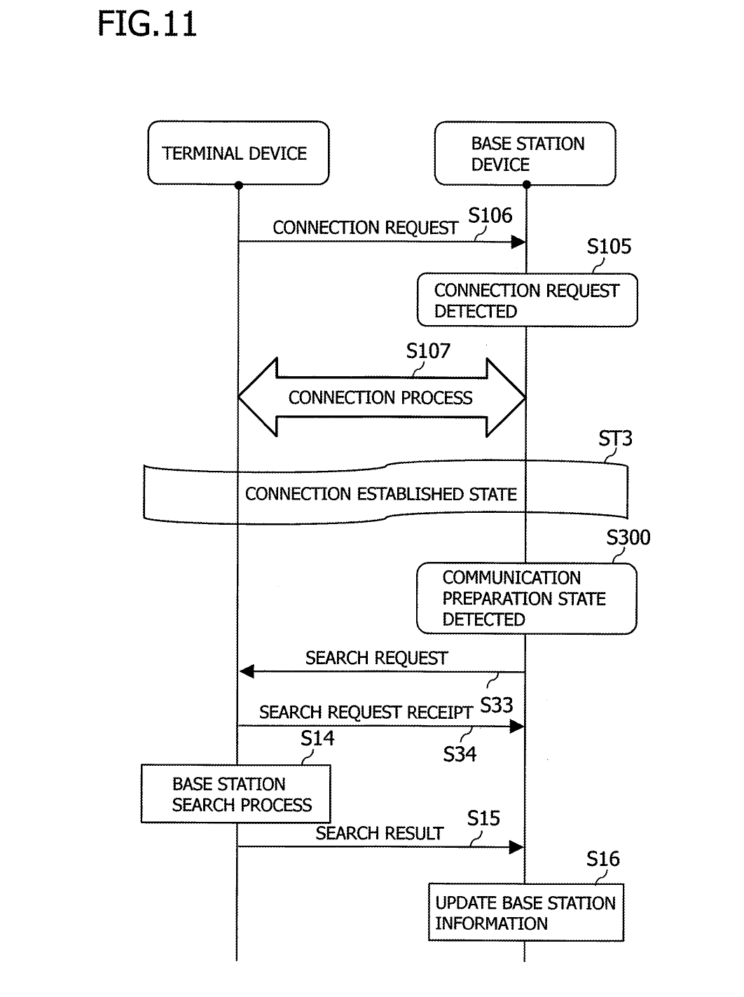

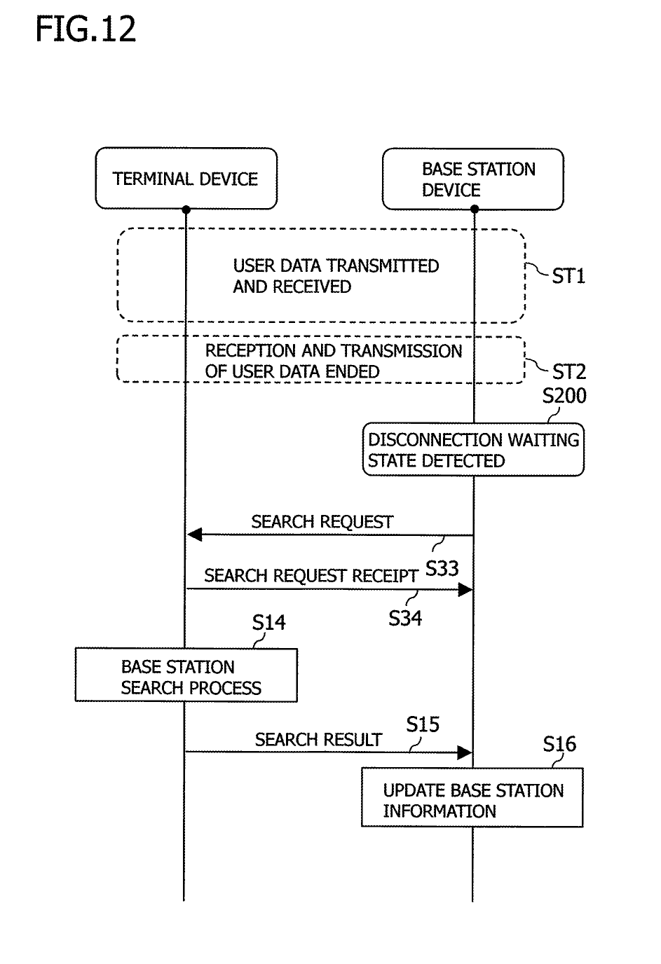

FIG. 10 is a flowchart of a process in which the base station device 200 updates the base station information in accordance with the second embodiment. The description given below refers to the flowchart in FIG. 10, and the sequences in FIGS. 11 and 12.

<1. Detection of Communication Preparation State>

FIG. 11 is a diagram illustrating an example of a sequence for detecting a communication preparation state by the base station device 200.

The base station device 200 confirms whether or not a connection has been established with the terminal device 100 (S103). The processing in a case where a connection has been established with the terminal device 100 (Yes in S103) is described below.

If a connection has not been established with the terminal device 100 (No in S103), then the base station device 200 confirms whether or not a connection request has been received from the terminal device 100 (S105). The fact that a connection has not been established with the terminal device 100 means that the terminal device 100 is not in the process of transmitting and receiving user data. Therefore, the terminal device 100 will subsequently transfer to a search-capable state when newly in the communication preparation state at the start of transmission and reception of user data. Therefore, the base station device 200 waits for a connection request which is a message received when the terminal device enters a connection preparation state. In an LTE communication system, the connection request is “Attach Request”, for example.

If a connection request has not been received (No in S105), then the base station device 200 waits until receiving a connection request. Upon receiving a connection request (S106) (Yes in S105), the base station device 200 carries out a connection process (S107). The base station device 200 detects that the terminal device 100 has entered into a communication preparation state (S300) by detecting the connection established state (ST3).

The method for detecting the connection established state (T3) involves detecting that a message indicating the completion of the connection process has been transmitted or received, among the messages transmitted and received in the connection process between the terminal device 100 and the base station device 200. In an LTE communication system, the message indicating the completion of the connection process is, for example, “RRC Connection Reconfiguration Complete”, which is transmitted by the terminal device 100. Alternatively, in an LTE communication system, the message indicating the completion of the connection process is, for example, “RRC Connection Reconfiguration”, which is transmitted by the base station device 200.

Upon completing the connection process, the base station device 200 considers the terminal device 100 to be in a communication preparation state (S300), and transmits a search request to the terminal device 100 (S33).

The processing after transmission of the search request by the base station device 200 until updating of the base station information is similar to the processing in S33, S34 and S14 to S16 of the sequence in FIG. 8 described in relation to the first embodiment.

In detecting the communication preparation state, immediately after the establishment of a connection with the terminal device 100, the base station device 200 considers that the terminal device 100 has not yet started the transmission and reception of user data, and therefore the terminal device 100 is determined to be in a search-capable state. Consequently, it is possible to transmit a search request when the CPU load in the terminal device 100 is small before the start of transmission and reception of user data, and hence there is an improved probability of being able to update the base station information.

<2. Detection of Disconnection Waiting State>

FIG. 12 is a diagram illustrating an example of a sequence for detecting a disconnection waiting state performed by the base station device 200. When a connection with the terminal device 100 has been established (Yes in S103), the base station device 200 confirms whether or not transmission and reception of user data has ended (S104). In the event of a failure to update the base station information despite the fact that a connection has been established with the terminal device 100, the base station device 200 can surmise that the terminal device 100 could not perform a search due to being in the process of transmitting and receiving user data (ST1). Thereupon, the base station device 200 can detect that the terminal device 100 has entered a disconnection wait state (S200), by detecting that transmission and reception of user data has ended (ST2).

The method for detecting that the transmission and reception of user data has ended (ST2) involves, for example, detecting that a prescribed time period has elapsed after the communication rate of the terminal device 100 has become equal to or lower than the reference value. The elapsing of a prescribed time period is set as a condition in order that a brief decline in the communication rate which may occur during the transmission and reception of user data is not mistakenly detected as a disconnection waiting state. Declines in the communication rate during the transmission and reception of user data are frequently very brief, with the communication rate returning immediately to a high rate, and hence there is a high probability that the terminal device 100 will not be able to perform a search for base station information upon receiving a search request in this case.

Upon detecting that the transmission and reception of user data has ended (Yes in S104), the base station device 200 considers that the terminal device 100 is in a disconnection waiting state (S200), and transmits a search request to the terminal device 100 (S33).

The processing after transmission of the search request by the base station device 200 until updating of the base station information is similar to the processing in S33, S34 and S14 to S16 of the sequence in FIG. 8 described in relation to the first embodiment.

By detecting the disconnection waiting state in this way, it is possible to transmit a search request after the terminal device 100 has completed the transmission and reception of user data and before the terminal device 100 disconnects, and hence there is an improved probability of being able to update the base station information.

### Third Embodiment

Next, a third embodiment will be described.

In the third embodiment, the base station device 200 compulsorily restricts the communication rate of the terminal device 100 to a reference value or lower, and by this restriction, detects that the terminal device 100 is in a search-capable state.

<State Capable of Searching for Base Station Information>

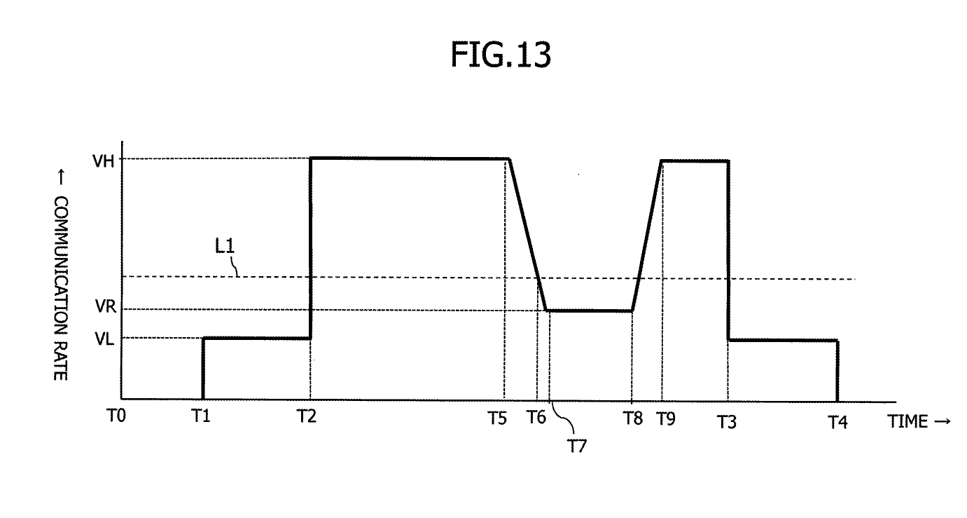

FIG. 13 is a diagram illustrating an example of change in the communication rate of the terminal device 100 with the passage of time. A search-capable state other than the communication preparation state and the disconnection waiting state described in the second embodiment is explained here with reference to FIG. 13.

In the third embodiment, the terminal device 100 is able to search for the base station information in a restricted communication period which is generated by compulsorily limiting the communication rate, apart from the search-capable states according to the second embodiment. A state where the terminal device 100 is in a restricted communication period is called a restricted communication state.

If a search request is transmitted when the terminal device 100 is communicating at a communication rate equal to or higher than the reference value, the terminal device 100 does not perform a search for base station information, and the base station device 200 fails to update base station information. Therefore, the base station device 200 monitors the operational state of the terminal device 100 until the terminal device 100 transfers to the disconnection waiting state (time period T3 to T4). However, the base station device 200 is not able to update the base station information until time T3 when the terminal device 100 transfers to the disconnection waiting state. For example, there are cases where the user of the terminal device 100 is transmitting and receiving video image data of long duration, for example, and hence the base station information is not able to be updated for a long time. Therefore, in the third embodiment, in order to avoid cases where the base station information is not able to be updated for a long time, a restricted communication state is generated compulsorily, and updating of the base station information is carried out.

The time period T1 to T4 in FIG. 13 is similar to FIG. 9 which was described in relation to the second embodiment. The time period from time T5 to T9 is described below.

Time T5 is the time at which the base station device 200 starts a restriction in order that the communication rate of the terminal device 100 becomes equal to or lower than the reference value. The restricted communication rate of the terminal device 100 becomes equal to or lower than the reference value at time T6. Thereupon, at time T7, the communication rate falls to the rate indicated by the restriction from the base station device 200.

At time T8, the restriction of the communication rate of the terminal device 100 by the base station device 200 is cancelled. When the restriction has been cancelled, the communication rate of the terminal device 100 gradually rises and, at time T9, reaches the communication rate prior to the restriction.

By restricting the communication rate of the terminal device 100, the period from time T6 at which the communication rate of the terminal device 100 becomes equal to or lower than the reference value, until time T8 at which the restriction of the communication rate is cancelled, is a restricted communication period. The base station device 200 has an improved probability of acquiring base station information by transmitting a search request to the terminal device 100 during the restricted communication period.

<Example of Configuration of Base Station Device>

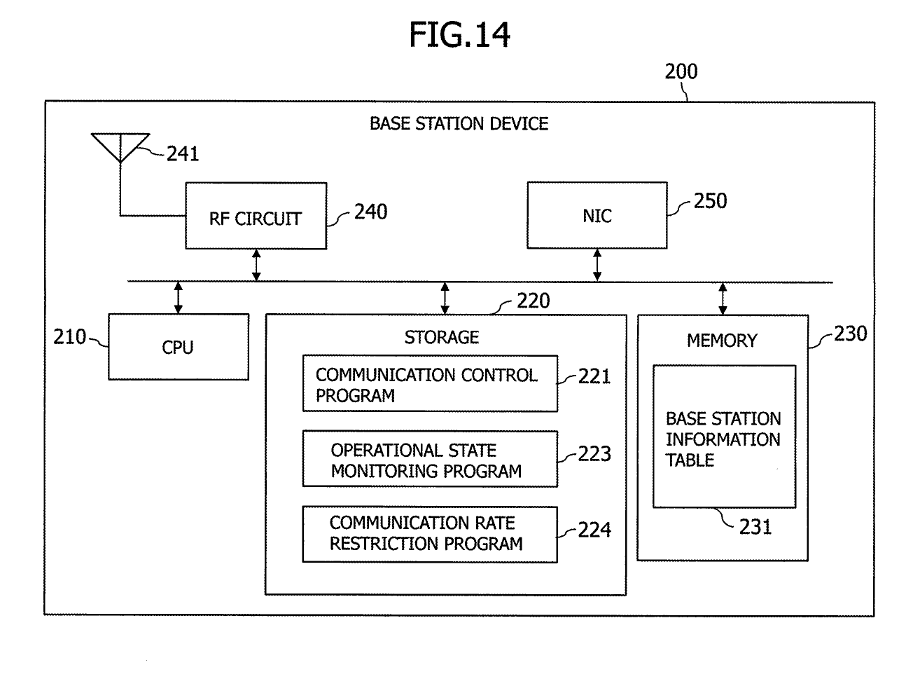

FIG. 14 is a diagram illustrating a configuration of a base station device 200 according to the third embodiment.

The storage 220 of the base station device 200 stores a communication rate restriction program 224, in addition to the communication control program 221 and operational state monitoring program 223.

The CPU 210 achieves a communication rate restriction process by executing the communication rate restriction program 224.

The communication rate restriction process is a process for transmitting a search request to the terminal device 100 when the terminal device 100 has been transferred compulsorily to a restricted communication state and is detected to be in the restricted communication state.

In the communication restriction process, the base station device 200 restricts the communication rate of the terminal device 100 so as to be equal to or lower than the reference value. In an LTE communication system, for example, the base station device 200 lowers the communication rate by reducing the resource block (RB) in relation to the terminal device 100. The RB is a wireless resource of frequencies that can be used for communication, divided up by bandwidth and time units.

The base station device 200, upon detecting that the terminal device 100 has transferred to a restricted communication state, transmits a search request to the terminal device 100. Upon receiving a search result from the terminal device 100, the base station device 200 then updates the base station information.

Moreover, upon completing the updating of the base station information, the base station device 200 cancels the restriction of the communication rate of the terminal device 100 and allows the terminal device 100 to communicate at the communication rate before restriction.

<Communication Rate Restriction Process>

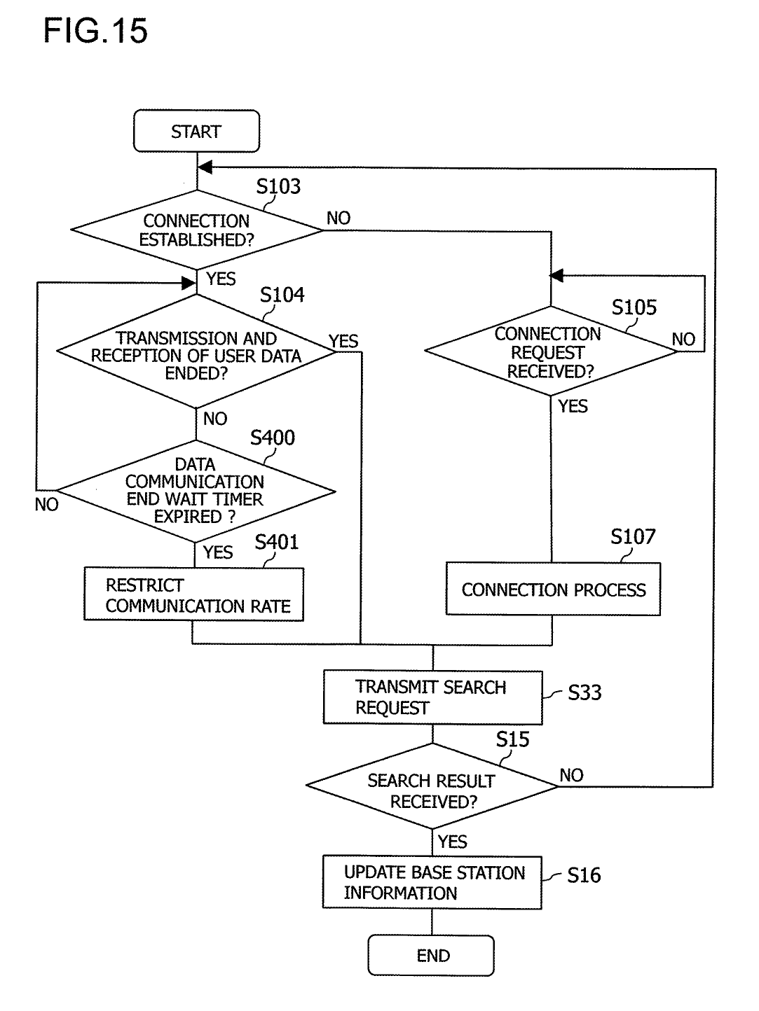

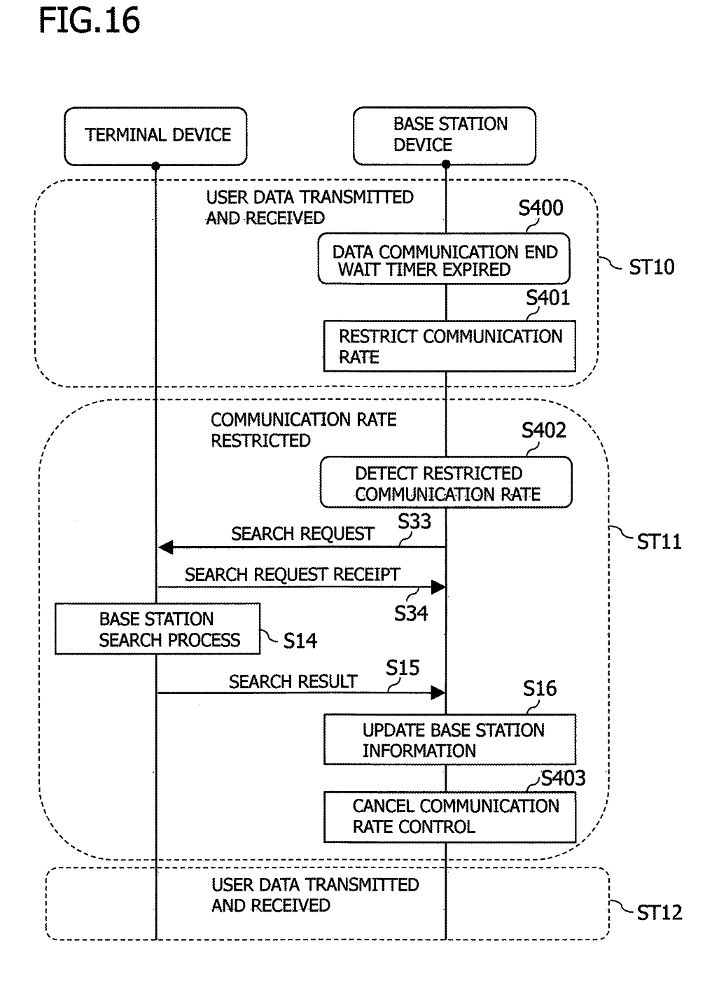

FIG. 15 is a diagram illustrating an example of a flowchart including a communication rate restriction process performed by the base station device 200. Furthermore, FIG. 16 is a diagram illustrating an example of a sequence of a communication rate restriction process. Below, the process of the sequence in FIG. 16 is described with reference to the flowchart in FIG. 15. The processing other than S400 and S401 in the flowchart in FIG. 15 is similar to the processing illustrated in FIG. 10 relating to the second embodiment.

The base station device 200 waits for the terminal device 100 to transfer to a disconnection waiting state. However, the terminal device 100 is in a state of transmitting and receiving user data at a communication rate equal to or greater than the reference value (ST10). In this state, the data communication end wait timer expires (S400). The data communication end wait timer is a timer for waiting for the terminal device 100 to transfer to a disconnection waiting state and is generated, for example, when the communication rate of the terminal device 100 becomes equal to or greater than the reference value. Furthermore, the data communication end wait timer may be generated when it is confirmed that a connection with the terminal device 100 has been established.

Upon expiry of the data communication end wait timer, the base station device 200 restricts the communication rate of the terminal device 100 (S401). The restriction of the communication rate is carried out by reducing the wireless resources that can be used by the terminal device 100, for example. Thereafter, the base station device 200 monitors the communication rate of the terminal device 100.

In the terminal device 100 subjected to restriction of the communication rate, the communication rate declines and becomes equal to or lower than the reference value (ST11). The base station device 200 detects that the communication rate of the terminal device 100 has become equal to or lower than the reference value, and thereby detects that the terminal device 100 has transferred to a search-capable state (S402). The base station device 200, upon detecting the search-capable state, transmits a search request to the terminal device 100 (S33). The processing from the transmission of a search request by the base station device 200 until the updating of the base station information is similar to the processing in S33, S34 and S14 to S16 of the sequence illustrated in FIG. 8 described in relation to the first embodiment.

The base station device 200 which has updated the base station information then cancels the restriction of the communication rate applied to the terminal device 100 (S403). After cancelling the restriction of the communication rate, the terminal device 100 returns the communication rate again to the communication rate before restriction, and carries out transfer and reception of user data (ST12).

In the third embodiment, a search-capable state is generated in which the communication rate of the terminal device 100 is compulsorily set to be equal to or lower than a reference value. When the terminal device 100 has not transferred to the disconnection waiting state or communication preparation state for a long time, it is possible to avoid a situation where the base station information is not updated for a long time, by compulsorily setting the terminal device 100 to a search-capable state.

### Fourth Embodiment

Next, a fourth embodiment of the invention will be described.

In the fourth embodiment, when it has not been possible to detect a disconnection waiting state or a communication preparation state for a certain time, in the operational state monitoring process, the terminal device 100 is compulsorily transferred to a restricted communication state and a search request is transmitted.

<Base Station Information Acquisition Process>

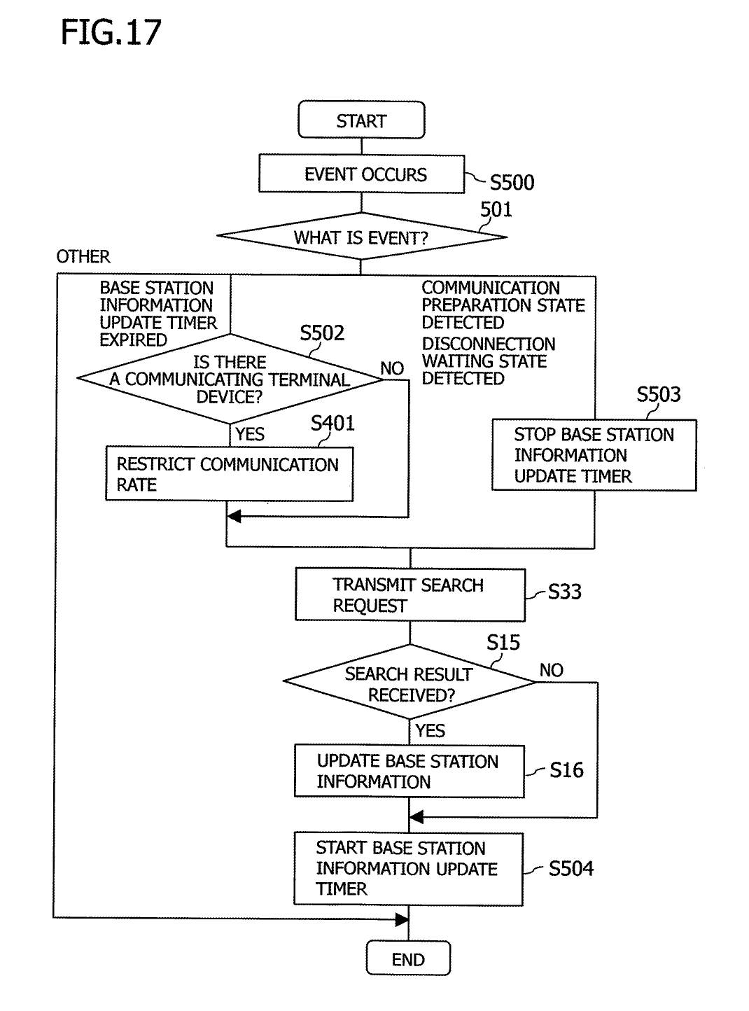

FIG. 17 is a diagram illustrating an example of a flowchart of a base station information acquisition process performed by the base station device 200 according to the fourth embodiment.

Upon the occurrence of any event (S500), the base station device 200 branches to a different process, depending on the type of event (S501).

Upon detecting that the terminal device is in a disconnection waiting state or communication preparation state (detection of disconnection waiting state or communication preparation state in S501), the base station device 200 stops the base station information update timer (S503). The method for detecting the disconnection waiting state and communication preparation state is the same as in the second embodiment.

The base station update timer is a timer that is used when the base station device 200 updates the base station information. The object of the base station information update timer is to avoid situations where updating of the base station information is not carried out for a time equal to or greater than the time of the base station information update timer. Therefore, the base station device 200, upon detecting a disconnection waiting state and/or communication preparation state, stops the base station information update timer at this detection timing, in order to transmit a search request and update the base station information by the subsequent processing (S503).

The subsequent processing from the transmission of a search request by the base station device 200 to updating of the base station information is similar to the first embodiment.

On the other hand, if the base station device 200 has not been able to detect a disconnection waiting state or communication preparation state and has not updated the base station information, while the base station information update timer is started, then the base station information update timer expires (base station information update timer expires in S501). The base station device 200 confirms whether or not there is a terminal device that is communicating (S502), and if there is a communicating terminal device (Yes in S502), restricts the communication rate of the terminal device (S401). The process for restricting the communication rate is similar to the communication rate restriction process according to the third embodiment. Furthermore, the processing from the transmission of the search request by the base station device 200 until the updating of the base station information is similar to the first embodiment.

When updating of the base station information has been completed (S16), the base station device 200 starts the base station information update timer (S504) and ends the process.

In the fourth embodiment, by providing a base station information update timer, the time during which the base station information is not updated is, at most, the timer value of the base station information update timer, and therefore the frequency of updating of the base station information can be increased.

### Fifth Embodiment

Next, a fifth embodiment will be described.

In the fifth embodiment, an operational state monitoring process is carried out when a periodic acquisition process is carried out and there is a failure to update the base station information in the periodic acquisition process.

<Example of Configuration of Base Station Device>

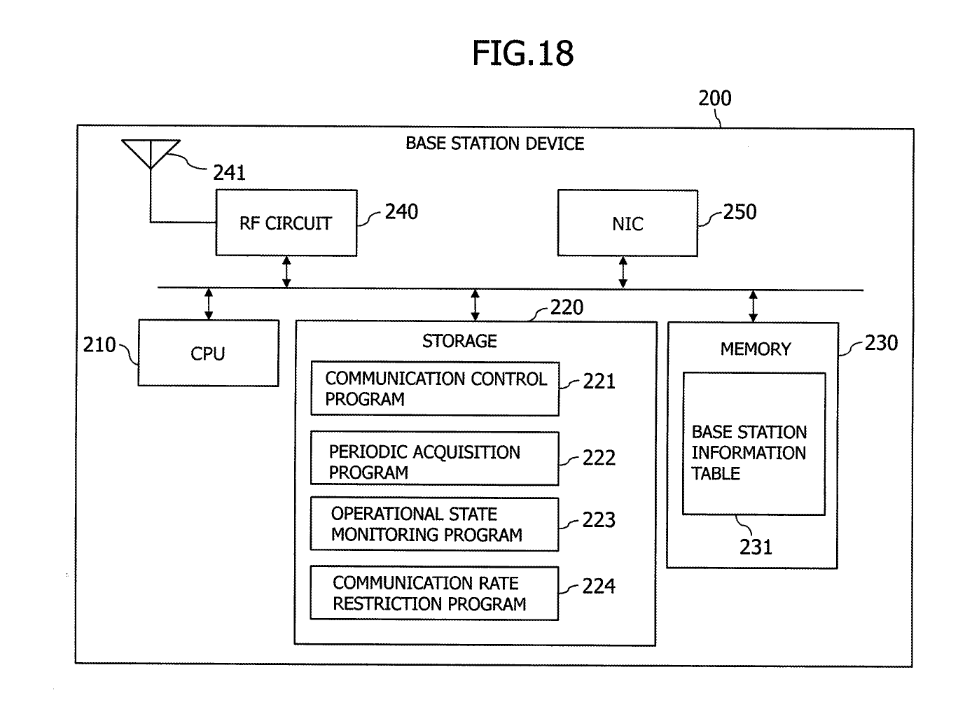

FIG. 18 is a diagram illustrating an example of the configuration of a base station device 200 according to the fifth embodiment.

The storage 220 of the base station device 200 stores a periodic acquisition program 222, in addition to the communication control program 221, the operational state monitoring program 223, and the communication rate restriction program 224.

The CPU 210 achieves the functions of the processing unit and the periodic acquisition unit, by executing the loaded programs.

The CPU 210 achieves a periodic acquisition process by executing the periodic acquisition program 222.

The periodic acquisition process is a process for periodically acquiring base station information, which achieves a periodic acquisition method. In the periodic acquisition process, the base station device 200 starts up a periodic acquisition timer for periodically acquiring base station information. Upon expiry of the periodic acquisition timer, the base station device 200 transmits a search request to the terminal device 100. Upon receiving a search result from the terminal device 100, the base station device 200 updates the base station information in the base station information table 231.

<Base Station Information Acquisition Process>

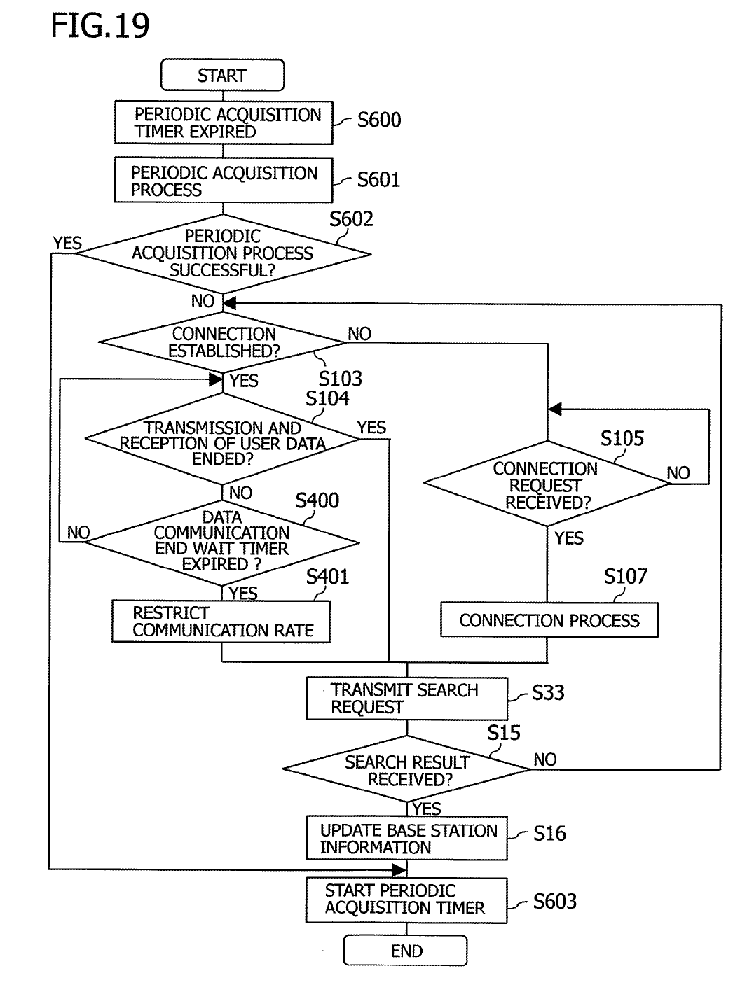

FIG. 19 is a diagram illustrating an example of a flowchart of the base station information acquisition process performed by the base station device 200 according to the fifth embodiment. The processing apart from S600 to S603 in

FIG. 19 is similar to the third embodiment.

Upon expiry of the periodic acquisition timer (S600), the base station device 200 carries out a periodic acquisition process (S601). In the periodic acquisition process, the base station device 200 transmits a search request to the terminal device 100 without determining the operational state of the terminal device 100.

If the base station information is successfully updated by the periodic acquisition process (Yes in S602), the base station device 200 starts a periodic acquisition timer (S603) and ends the process.

If the base station device 200 fails to update the base station information by the periodic acquisition process (No in S602), then the base station device 200 carries out an operational state monitoring process. When the base station information is subsequently updated (S16), the periodic acquisition timer is started (S603), and the process is ended.

In this way, in the fifth embodiment, an operational state monitoring process is carried out when there has been a failure to updating the base station information on the basis of a periodic acquisition process. As the number of terminal devices served by the base station device 200 increases, the possibility of all of the terminal devices not being in a state capable of searching for the base station information becomes lower, and the possibility of the base station device 200 being able to receive a search result from at least one terminal device becomes higher. In other words, in a situation where a large number of terminal devices are served by a base station device, there is a high probability of being able to update the base station information, even without carrying out a state monitoring process. Consequently, by carrying out the operational state monitoring process only when the periodic acquisition process has failed, it is possible to improve the updating of the base station information, while reducing the occurrence of wasteful transmissions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station device comprising:
a communication unit which connects wirelessly to, and communicates with, a terminal device located within a range capable of wireless communication; and
a processing unit which carries out a search request process of requesting the terminal device to search for a base station device, to which the terminal device is capable of connecting, and to transmit base station information acquired by the search to the base station device, wherein
the processing unit acquires operational information indicating change in an operational state of the terminal device, and carries out the search request process when it is determined based on the acquired operational information that the terminal device is in a first state in which the terminal device is capable of performing the search for a base station device.

2. The base station device according to claim 1, wherein the first state includes a second state in which a communication rate of the terminal device is equal to or lower than a reference value.

3. The base station device according to claim 2, wherein the second state includes a communication preparation period from when the terminal device establishes a connection with the base station device until when the terminal device starts communication with the base station device at a communication rate exceeding the reference value.

4. The base station device according to claim 3, wherein the communication preparation period includes a period after a message indicating the establishment of the connection between the terminal device and the base station device is received from the terminal device, or is transmitted to the terminal device.

5. The base station device according to claim 2, wherein the second state includes a disconnection waiting period from when the terminal device ends communication with the base station device at a communication rate exceeding the reference value, until when the terminal device disconnects the connection established with the base station device.

6. The base station device according to claim 5, wherein the disconnection waiting period includes a period after a first time period has expired since the communication rate of the terminal device has become equal to or lower than the reference value.

7. The base station device according to claim 2, wherein the second state includes a restricted communication period during which the communication rate of the terminal device is restricted so as be equal to or lower than the reference value.

8. The base station device according to claim 7, wherein the restricted communication period includes a period after the communication rate of the terminal device has become equal to or lower than the reference value, due to the processing unit restricting the communication rate of the terminal device so as to be equal to or lower than the reference value.

9. The base station device according to claim 2, wherein, in cases where a communication preparation period from when the terminal device establishes a connection with a base station device until when the terminal device starts communication with the base station device at a communication rate exceeding the reference value, and a disconnection waiting period from when the terminal device ends communication at a communication rate exceeding the reference value until when the terminal device disconnects the connection established with the base station device, does not occur during a second time period, the processing unit restricts the communication rate of the terminal device so as to be equal to or lower than the reference value, and sets the terminal device to the second state due to the restriction.

10. The base station device according to claim 1, further comprising:
a periodic acquisition unit which carries out a periodic acquisition process for periodically transmitting the search request without determining whether the terminal device is in the first state, wherein
the processing unit acquires the operational information and carries out the search request process when it is determined based on the acquired operational information that the terminal device is in the first state, when reception of the search result in relation to the search request transmitted in the periodic acquisition process is impossible, and carries out the search request process when determination is made from the acquired operational information that the terminal device is in the first state.

11. The base station device according to claim 1, wherein the base station information includes an identifier of a base station device to which the terminal device is capable of connecting.

12. A base station device comprising:
a memory; and
a processor, coupled to the memory, that executes
acquiring operational information indicating change in an operational state of a terminal device that connects wirelessly to and communicates with the base station device,
determining, based on the acquired operational information, if the terminal device is in a first state or not in which the terminal device is capable of performing a search for a base station device, and
requesting the terminal device to execute the search for a base station device to which the terminal device is capable of connecting, and to transmit base station information acquired by the search to the base station device, when it is determined that the terminal device is in the first state.
